(19) United States
(12) Patent Application Publication
(10) Pub. No.: US 2023/0265229 A1
(43) Pub. Date: Aug. 24, 2023

(54) AQUEOUS POLYMER DISPERSION FOR ADHESIVE FORMULATIONS

(71) Applicant: BASF SE, Ludwigshafen am Rhein (DE)

(72) Inventors: Timo MANGEL, Ludwigshafen am Rhein (DE); Valerie WILMS, Ludwigshafen am Rhein (DE); Lisa HOUILLOT, Ludwigshafen am Rhein (DE); Maximilian RUELLMANN, Ludwigshafen am Rhein (DE); Thomas KOCH, Ludwigshafen am Rhein (DE); Rene LATOUR, Ludwigshafen am Rhein (DE); Saskia STEINBRUECK, Ludwigshafen am Rhein (DE)

(21) Appl. No.: 18/014,492

(22) PCT Filed: Jul. 8, 2021
(86) PCT No.: PCT/EP2021/069006

§ 371 Date: Jan. 5, 2023

(30) Foreign Application Priority Data
Jul. 9, 2020 (EP) 20185019.5

(51) Int. Cl. C08F 220/18; C09J 133/10

(52) U.S. Cl. CPC C08F 220/1808; C08F 220/1804; C09J 133/10

(57) ABSTRACT

The present invention relates to aqueous polymer dispersions of polymers made of polymerized ethylenically unsaturated monomers M which comprise or consist of: a) 55 to 88% by weight, based on the total weight of the monomers M, of at least one monomer Ma consisting of a1) at least one monomer Ma(1) selected from alkyl acrylates having a branched alkyl radical having 3 to 20 carbon atoms, alkyl methacrylates having a branched alkyl radical having 5 to 20 carbon atoms, where the homopolymer of monomer Ma(1) has a theoretical glass transition temperature of at most 10° C. and optionally a2) at least one monomer Ma(2) selected from alkyl acrylates having a linear alkyl radical of 2 to 6 carbon atoms; wherein the weight ratio of monomer Ma(2) to Ma(1) is at most 2:1; b) 8 to 30% by weight, based on the total weight of the monomers M, of a monomer Mb, which is a monoethylenically unsaturated carbonitrile; c) 0 to 25% by weight, based on the total weight of the monomers M, of at least one non-ionic monoethylenically unsaturated monomer Me which is different from the monomers Mb and whose homopolymer has a glass transition temperature of at least 60° C.; provided that the total amount of monomer Mb and Me is in the range of 12 to 40% by weight, based on the total weight of the monomers M; d) at most 2.0% by weight, based on the total weight of the monomers M, of one or more monoethylenically unsaturated monomers Md having an acidic group; e) at most 5% by weight, based on the total weight of the monomers M, of at least one ethylenically unsaturated monomer Me which, alone or with a crosslinking agent, has crosslinking effect and which is different from the monomers Ma to Md; f) at most 10% by weight based on the total weight of the monomers M, of at least one non-ionic monoethylenically unsaturated monomer Mf which has a water-solubility of at least 100 g/L and which is different from the monomers Me; provided that the total amount of monomers Md, Me and Mf does not exceed 10% by weight, based on the total weight of the monomers M. The polymers are suitable as polymer adhesives, in particular as polymer adhesives or binders, respectively, in aqueous flooring adhesive compositions.

The present invention relates to aqueous polymer dispersions of polymers made of polymerized ethylenically unsaturated monomers M comprising alkyl (meth)acrylates as main monomers and monoethylenically unsaturated carbonitrile. The polymers are suitable as polymer adhesives, in particular as polymer adhesives or binders, respectively, in aqueous flooring adhesive compositions.

Aqueous polymer dispersions of polymerized ethylenically unsaturated monomers, also referred to as polymer latex, are fluid systems comprising dispersed polymer particles of a chain growth addition polymer in the aqueous dispersing medium. Depending on their polymer architecture, they can be used across a plethora of technical applications, including waterborne coating formulations for interior and exterior application and as polymer adhesive component in aqueous adhesive formulations.

Fundamental requirements of adhesives, in particular flooring adhesives, are effective adhesion of the adhesive to the substrates and effective cohesion in the layer of adhesive. Optimizing these properties at one and the same time presents problems, since in general an improvement in the adhesive properties is accompanied by a reduction in the cohesive properties of an adhesive, and vice versa.

With flooring adhesives there are further requirements to be met. Since floor coverings are usually glued over large areas, flooring adhesives require good adhesive properties in the wet and dry states. This means that the adhesive must exhibit sufficient tack both in the first minutes after laying of the adhesive and after a prolonged venting time. These two properties, referred to as wet tack and dry tack, also termed wet grab and dry grip, are difficult to combine. An improvement in one property has so far typically entailed a deterioration in the other. Furthermore, emissions ought to be kept as low as possible, this being achievable by avoiding the use of any solvents, including high-boiling solvents, in the formulation or using them in the lowest possible amount. It is apparent that it is difficult to achieve all these requirements at the same time.

Aqueous polymer dispersions wherein the polymers are made of polymerized ethylenically unsaturated monomers M comprising alkyl (meth)acrylates as main monomers, and the use thereof as polymer adhesives/binders in aqueous flooring adhesive compositions have been known for a long time, e.g. from WO 95/21884, WO 98/56867, WO 99/37716 and WO 2007/141198. However, the adhesive properties of these polymer dispersions are not all satisfactory.

WO 2016/008834 describes aqueous polymer dispersions of a polymer constructed from at least one ester of an ethylenically unsaturated carboxylic acid, at least one ethylenically unsaturated carbonitrile, at least one acid-functional ethylenically unsaturated monomer, at least one monomer which, alone or with a crosslinking agent, has crosslinking effect and which is different from the aforementioned monomers and at least one ethylenically unsaturated monomer which has a chain growth addition homopolymer having a glass transition temperature 50° C. The polymer is prepared by aqueous emulsion polymerization in the presence of 10 to 60 parts by weight, based on 100 parts by weight of the monomers, of at least one saccharide polymer such as a maltodextrin. The saccharide polymer has a significant impact on the adhesive properties. However, the stability under alkaline conditions is not satisfactory.

Due to their high content of organic matter, current aqueous adhesive formulations based on aqueous polymer dispersions, such as flooring adhesives, are sensitive to microbial infestation such as fungi, yeast or bacteria. Therefore, they must be stabilized against microbial infestation with preservation agents, in particular organic biocides, such as thiazolinones and formaldehyde releasers, such as DM DM hydantoin or methylol urea. These organic biocides may cause allergic skin reaction, and the allowed maximum concentrations have been significantly reduced in recent years, and reliable preservation is becoming increasingly difficult.

It is known to stabilize aqueous paint formulations for interior application (interior paints) by buffering them at high pH levels of e.g. at least pH 9, in particular at least pH 10 or higher, e.g. in the range of pH 10 to 12, see e.g. DE 102004023374, WO 2002/000798, DE 102014013455 and DE 102018004944. Suitable buffers suggested therein include alkalimetal silicates, alkalimetal siliconates and alkanol amines.

The attempt to transfer the preservation principle known for interior paints to aqueous adhesive formulations, especially flooring adhesive formulations, was not successful for formulations based on alkyl (meth)acrylate polymer dispersions suitable for flooring adhesives. The polymer dispersions turned out to be instable at the high pH values necessary for achieving preservation without organic biocides when stored for prolonged time and/or subjected to elevated temperature. In particular, both the polymer dispersion and the adhesive formulations tend to show a significant increase in viscosity when stored for prolonged time, and the polymer dispersions tend to coagulate at high pH values. Moreover, the polymer dispersions form alcohols at high pH values, probably by hydrolysis of the polymerized (meth)acrylates.

It is, therefore, an object of the present invention to provide aqueous polymer dispersions which can be formulated in adhesive formulations, in particular in aqueous flooring adhesive formulations, which have a high pH value of at least pH 9 or at least pH 10. The aqueous polymer dispersions should provide good adhesive properties to the aqueous adhesive formulations, in particular a high strength in the adhesive bond, i.e. good adhesion to the substrate and cohesion in the adhesive layer, and good application properties such as good wet grab and dry grip.

In a first attempt, the inventors of the present invention tried to achieve this object by modifying aqueous polymer dispersions known to be suitable as polymer adhesive or binder components in aqueous adhesive formulations, respectively, by rendering them more hydrophobic to reduce the problem of hydrolysis. However, this attempt failed as the adhesive properties and the application properties were significantly deteriorated. The inventors now surprisingly found that the aqueous polymer dispersions made of the composition of ethylenically unsaturated monomers M as defined herein achieve these objectives. These monomers M comprise or consist of:

a) 55 to 88% by weight, in particular 55 to 80% by weight and especially 60 to 80% by weight, based on the total weight of the monomers M, of at least one monomer Ma which consists of
a1) at least one monomer Ma(1) selected from alkyl acrylates having a branched alkyl radical having 3 to 20 carbon atoms, alkyl methacrylates having a branched alkyl radical having 5 to 20 carbon atoms, where the homopolymer of monomer Ma(1) has a theoretical glass transition temperature of at most 10° C. and optionally
a2) at least one monomer Ma(2) selected from alkyl acrylates having a linear alkyl radical of 2 to 6 carbon atoms;
   wherein the weight ratio of monomer Ma(2) to Ma(1) is at most 2:1, in particular at most 1.8:1, e.g. in the range of 1:10 to 2:1, more particularly in the range of 1:8 to 1.8:1;

b) 8 to 30% by weight, in particular 12 to 28% by weight, especially 14 to 25% by weight, based on the total weight of the monomers M, of a monomer Mb which is a monoethylenically unsaturated carbonitrile;

c) 0 to 25% by weight, in particular 2 to 20% by weight, especially 4 to 20% by weight, based on the total weight of the monomers M, of one more non-ionic monoethylenically unsaturated monomers Mc which are different from the monomers Mb and Me and whose homopolymers have glass transition temperatures of at least 60° C.;
provided that the total amount of monomer Mb and Mc is in the range of 12 to 40% by weight, in particular 14 to 39.99% by weight or 14 to 39.94% by weight, especially 16 to 39.85% by weight or 16 to 39.45% by weight, based on the total weight of the monomers M;

d) at most 2.0% by weight, in particular 0 to 1.5% by weight or 0.01 to 1.5% by weight, especially 0 to 1% by weight or 0.05 to 1% by weight, based on the total weight of the monomers M, of one or more monoethylenically unsaturated monomers Md having an acidic group;

e) at most 5% by weight, e.g. 0.01 to 5% by weight, in particular 0 to 2% by weight, e.g. 0.05 to 5% by weight, based on the total weight of the monomers M, of one or more ethylenically unsaturated monomers Me which, alone or with a crosslinking agent, have crosslinking effect and where the monomer Me is different from the monomers Ma to Md;

f) at most 10% by weight, e.g. 0.1 to 10% by weight, in particular 0 to 5% by weight, e.g. 0.5 to 5% by weight, based on the total weight of the monomers M, of one or more non-ionic monoethylenically unsaturated monomer Mf which have a water-solubility of at least 100 g/L and which are different from the monomers Me and also from monomers Ma to Md;

provided that the total amount of monomers Md, Me and Mf does not exceed 10% by weight, based on the total weight of the monomers M.

Thus, the present invention relates to aqueous polymer dispersions made of ethylenically unsaturated monomers M as defined herein. The present invention also relates to a process for preparing the aqueous polymer dispersion of the present invention which comprises an aqueous emulsion polymerization, in particular free radical aqueous emulsion polymerization, of the monomers M. The present invention also relates to the aqueous polymer dispersions obtainable by this process.

The present invention is associated with several benefits. The polymer dispersions of the present invention provide good adhesion and can be formulated in adhesive formulations, in particular in aqueous flooring adhesive formulations, which have a high pH value of at least pH 10 without suffering from increased viscosity or deterioration of the adhesive formulation. The aqueous polymer dispersions provide good adhesive properties to the aqueous adhesive formulations, in particular a high strength in the adhesive bond, i.e. good adhesion to the substrate and cohesion in the adhesive layer, and good application properties such as good wet grab and dry grip, even at the high pH levels of the adhesive formulations. The aqueous polymer dispersions are, therefore, particularly suitable for flooring adhesive formulations with high pH values.

Therefore, further aspects of the present invention relate to use of the aqueous polymer dispersions of the present invention as a polymer adhesives/binders in an aqueous adhesive formulations having a pH of at least pH 10, in particular in the range of pH 10.5 to pH 11.5, in particular in aqueous flooring adhesive formulations having a pH of at least pH 10, in particular in the range of pH 10.5 to pH 11.5.

Here and throughout the specification, the terms “wt %”, “% b.w.” and “% by weight” are used synonymously.

Here and throughout the specification, the indefinite article “a” comprises the singular but also the plural, i.e. an indefinite article in respect to a component of a composition means that the component is a single compound or a plurality of compounds. If not stated otherwise, the indefinite article “a” and the expression “at least one” are used synonymously.

Here and throughout the specification, the term “pphm” means parts by weight per 100 parts of monomers and corresponds to the relative amount in % by weight of a certain monomer based on the total amount of monomers M.

Here and throughout the specification, the terms “ethoxylated” and “polyethoxylated” are used synonymously and refer to compounds having an oligo- or polyoxyethylene group, which is formed by repeating units O—CH₂CH₂. In this context, the term “degree of ethoxylation” relates to the number average of repeating units O—CH₂CH₂ in these compounds.

Here and throughout the specification, the term “ethylenically unsaturated” means that the respective compound, i.e. the monomer, has at least one C═C double bond which is capable to undergo a chain-growth polymerization reaction. Here and throughout the specification, the term “monoethylenically unsaturated” means that the respective compound, i.e. the monomer, has exactly 1 C═C double bond which is capable to undergo a chain-growth polymerization reaction.

Here and throughout the specification, the term “non-ionic” in the context of compounds, especially monomers, means that the respective compound does not bear any ionic functional group or any functional group which can be converted by protonation or deprotonation into an ionic group.

Here and throughout the specification, the term “alkyl acrylate” refers to an alkyl ester of acrylic acid. Likewise, the term “alkyl methacrylate” refers to an alkyl ester of methacrylic acid. In the alkyl acrylates and the alkyl methacrylates the alkyl radical corresponds to the alkanol with which acrylic acid or methacrylic acid is esterified.

Linear alkyl radicals having 2 to 6 carbon atoms include ethyl, n-propyl, n-butyl, n-pentyl and n-hexyl.

Branched alkyl radicals having 3 to 20 carbon atoms include but are not limited to 2-propyl, 2-butyl, isobutyl, tert.-butyl, 2-pentyl, 3-pentyl, 2-methyl-1-butyl, 3-methyl-1-butyl, 2,2-di methyl propyl, 1,2-dimethylpropyl, 2-hexyl, 3-hexyl, 2-methylpentyl, 3-methylpentyl, 4-methylpentyl, 1,2-dimethylbutyl, 1,3-dimethylbutyl, 2,2-dimethylbutyl, 2,3-dimethylbutyl, 2-ethyl-1-butyl, 2-heptyl, 3-heptyl, 4-heptyl, 2-methyl-1-hexyl, 2-ethyl-1-pentyl, 2,2-dimethylpentyl, 2-octyl, 3-octyl, 3-octyl, 2-methyl-1-heptyl, 3-methyl-1-heptyl, 2-ethyl-1-hexyl, 1,3-dimethylhexyl, 1,4-dimethylhexyl, 2,3-dimethylhexyl, 2,4_dimethylhexyl, 2,2,4-dimethylhexyl, 1,3,5-dimethylhexyl, 2-nonyl, 2-methyloctyl, 3-methyloctyl, 2-ethylheptyl, 2-decyl, 2-methylnonyl, 2-ethyloctyl, 2-propylheptyl, 2-undecyl, 2-dodecyl, 1,3,5,7,-tetramethyloctyl, 2,2,4,4,6-pentamethylheptyl, 2-tridecyl, 2-tetradecyl, 2-pentadecyl, 2-hexadecyl, 2-heptadecyl, 2-octadecyl, 2-nonadecyl, 2-eicosyl, etc.

According to the invention, the polymers of the aqueous polymer dispersion are formed from polymerized monomers M. The monomers M comprise at least one monomer Ma which consists at least one Ma(1) or of a combination of at least one monomer Ma(1) and at least one monomer Ma(2).

The monomer Ma(1) is selected from alkyl acrylates having a branched alkyl radical and alkyl methacrylates having a branched alkyl radical, provided that the homopolymer of the respective alkyl acrylate and the respective alkyl methacrylate has a glass transition temperature of at most +10° C., in particular at most 0° C., e.g. in the range of −100 to +10° C. or in the range of −80 to 0° C. The glass transition temperature for the homopolymers of most alkyl acrylate and alkyl methacrylate monomers are known and listed in T. G. Fox in Bull. Am. Phys. Soc. 1956, 1, page 123 and can also be found in Ullmann's Encyclopadie der technischen Chemie [Ullmann's Encyclopedia of Industrial Chemistry], 5th ed., vol. A21, p. 169, Verlag Chemie, Weinheim, 1992. Further sources of glass transition temperatures of homopolymers are, for example, J. Brandrup, E. H. Immergut, Polymer Handbook, 1st Ed., J. Wiley, New York 1966, 2nd Ed. J. Wiley, New York 1975, 3rd Ed. J. Wiley, New York 1989 and 4th Ed. J. Wiley, New York 2004 and Crow polymer data base (www.polymerdatabase.com). They can also be determined experimentally by the differential scanning calorimetry (DSC) method according to ISO 11357-2:2013, preferably with sample preparation according to ISO 16805:2003 and heating rate 20 K/min.

Examples of monomers Ma(1) include, but are not limited to isopropyl acrylate, 2-butyl acrylate, 2-ethylhexyl acrylate, 2-heptylpropyl acrylate, 2-ethylhexyl methacrylate and 2-heptylpropyl methacrylate.

The monomer Ma(1) is preferably selected from alkyl acrylates having a branched alkyl radical having 6 to 12 carbon atoms and mixtures thereof, examples including 2-ethylhexyl acrylate, 2-heptylpropyl acrylate, and mixtures thereof.

The total amount of monomers Ma(1) is preferably in the range of 25 to 88% by weight or 25 to 87% by weight, or 25 to 85% by weight, or 25 to 79% by weight or 25 to 75% by weight, in particular 30 to 80% by weight or 30 to 79% by weight or 30 to 75% by weight, based on the total weight of monomers M. If the monomers Ma consist of one or more monomers Ma(1), the amount of monomers Ma(1) is in the ranges given for monomers Ma. If the monomers Ma consist of a combination of monomers Ma(1) and Ma(2), the amount of monomers Ma(1) is typically in the range of 25 to 87% by weight, frequently in the range of 25 to 79% by weight, more preferably in the range of 25 to 75% by weight, in particular in the range of 30 to 87% by weight, more preferably in the range of 30 to 79% by weight, especially in the range of 30 to 75% by weight, based on the total weight of monomers M.

Examples of the monomer Ma2 include, but are not limited to ethyl acrylate, n-propyl acrylate, n-butyl acrylate, and n-hexyl acrylate with preference given to n-butyl acrylate and mixtures thereof with ethyl acrylate. If present, the total amount of monomers Ma(2) is preferably in the range of 1 to 50% by weight, in particular 5 to 50% by weight, based on the total weight of monomers M. However, the monomers Ma(2) may also be bsent.

The total amount of monomers Ma, i.e. the sum of the amount of monomers Ma(1) and Ma(2) is preferably in the range of 55 to 80% by weight, in particular in the range of 60 to 80% by weight, based on the total weight of the monomers M which form the polymer of the aqueous polymer dispersion.

The monomer Ma may consist only of one or more monomers Ma(1). In this case, the total amount of monomers Ma(2) is 0 and thus the weight ratio of the total amount of monomers Ma(2) to the total amount of monomers Ma(1) is 0. The monomer Ma may also consist of a combination of one or more monomers Ma(1) and one or more monomers Ma(2). In this case, the weight ratio of the total amount of monomers Ma(2) to the total amount of monomers Ma(1) is >0 and typically at least 0.1 or at least 0.125, e.g. in the range of 1:10 to 2:1, more particularly in the range of 1:8 to 1.8:1.

The monomers M forming the polymer of the aqueous polymer dispersion comprise a monoethylenically unsaturated carbonitrile which is hereinafter termed monomer Mb. The monoethylenically unsaturated carbonitrile has preferably 3 to 6 carbon atoms. The ethylenically unsaturated double bond is preferably in conjugation to the nitrile group. Examples of monomers Mb include acrylonitrile and methacrylonitrile with particular preference given to acrylonitrile. The amount of the monomer Mb is in particular 12 to 28% by weight, especially 14 to 25% by weight, based on the total weight of the monomers M.

The monomers M forming the polymer of the aqueous polymer dispersion may comprise a monoethylenically unsaturated monomer Mc, whose homopolymer has a glass transition temperature of at least 60° C., in particular at least 80° C., e.g. 6 to 200° C. or 80 to 180° C. The monomer Mc is, therefore, different from monomers Ma, whose homopolymers have significantly lower glass transition temperatures. The glass transition temperature for the homopolymers of monomers Mc are known from the above references, or they can also be determined experimentally by the differential scanning calorimetry (DSC) method as described above.

The monomer Mc is also different from monomers Md because it is non-ionic and thus does not bear an acid group. By definition, the monomer Mc is also different from the monomers Mb, Me and Mf. The monomer Mc is typically a non-polar monomer. Therefore, its solubility in deionized water at 20° C. and 1 bar is typically below 50 g/L, in particular below 30 g/L and thus lower than the solubility of monomers Mb which typically have solubility in deionized water of above 50 g/L at 20° C. and 1 bar. Moreover, the monomers Mc is typically not crosslinkable.

Preferably, the monomer Mc comprises or is at least one vinylaromatic hydrocarbon monomer, such as styrene, alpha-methylstyrene and vinyl toluene with preference given to styrene. Further possible monomers Mc include alkyl esters of methacrylic acid having a linear or branched alkyl radical of 1 to 4 carbon atoms, hereinafter also termed C₁-C₄-alkyl methacrylates, in particular C₃-C₄-alkyl methacrylates, wherein the alkyl radical is branched such as in isopropyl methacrylate and tert.-butyl.methacrylate and cylcoalkyl methacrylates such as cyclohexyl methacrylate or isobornyl methacrylate. In particular, the monomer Mc comprises or is at least one vinylaromatic hydrocarbon monomer, and is in particular styrene. The amount of the vinylaromatic monomer, in particular styrene, is in particular at least 50% by weight, especially at least 80% by weight and up to 100% by weight, based on the total amount of monomer Mc. Especially, the monomer Mc is at least one vinylaromatic hydrocarbon monomer, and is in particular styrene.

If present, the amount of monomer Mc is in the range of 1 to 25% by weight, in particular 2 to 20% by weight, especially 4 to 20% by weight, based on the total weight of the monomers M; provided that the total amount of monomer Mb and Mc is in the range of 12 to 40% by weight, or 12 to 39.99% by weight or 12 to 39.89% by weight, in particular 14 to 40% by weight or 14 to 39.99% by weight or 14 to 39.95% by weight or 14 to 39.89% by weight or 14 to 39.45% by weight, especially 16 to 40% by weight or 16 to 39.99% by weight or 16 to 39.95% by weight or 16 to 39.89% by weight or 16 to 39.45% by weight, based on the total weight of the monomers M.

It is apparent that the upper limitation of these weight ranges will have to be adapted depending on the amount of monomers Md, Me and Mf. In particular, the total amount of monomers Md, Me and Mf will usually not exceed 8% by weight, in particular 5% by weight, based on the total weight of the monomers M and is typically in the range of 0.01 to 10% by weight or 0.01 to 8% by weight, in particular in the range of 0.05 to 8% by weight or 0.05 to 5% by weight, more particularly 0.1 to 8% by weight or 0.1 to 5% by weight and especially 0.15 to 8% by weight or 0.15 to 5% by weight, based on the total weight of the monomers M. It is also apparent that these upper limits will have to be adapted such that the total amount of monomers Ma, Mb, Mc, Md, Me and Mf will not exceed 100% by weight. Apart from that, the total amount of monomers Ma, Mb, Mc, Md and Me is typically at least 98% by weight, in particular at least 99% by weight and especially at least 100% by weight based on the total weight of the monomers M.

The monomers M forming the polymer of the aqueous polymer dispersion may comprise a monoethylenically unsaturated monomer Md which has an acidic group such as a sulfonic, phosphonic, phosphoric or carboxylic acid group. The monomer may be present in the acidic form or in the neutralized form, e.g. in the form of a salt, in particular as an alkali metal salt or ammonium salt. If present, the amount of monomers Md is preferably in the range of 0.01 to 1.5% by weight, especially 0.05 to 1% by weight, based on the total weight of the monomers M. Even more preferred, the amount of monomers Md is less than 0.5% by weight, e.g. in the range of 0.05 to 0.4% by weight, based on the total weight of the monomers M. The relative amounts of monomers Md given here relate to the acidic form of the monomers Md.

Examples of monomers Md include monoethylenically unsaturated sulfonic acids such as vinylsulfonic acid, allylsulfonic acid, styrenesulfonic acid, 2-acrylamido-2-methyl-propane sulfonic acid, monoethylenically unsaturated phosphonic acids such as vinylphosphonic acid, allylphosphonic acid, styrenephosphonic acid and 2-acrylamido-2-methylpropane phosphonic acid, monoethylenically unsaturated phosphoric acids such as monophosphates of hydroxyalkyl acrylates, monophosphates of hydroxyalkyl methacrylates, monophosphates of alkoxylated hydroxyalkyl acrylates and monophosphates of alkoxylated hydroxyalkyl methacrylates, for example. Preferably, the monomers Md are monoethylenically unsaturated carboxylic acids, in particular C₃ to C₆, especially C₃ or C₄ monocarboxylic acids or C₄ to C₆ dicarboxylic acids such as acrylic acid, methacrylic acid, ethylacrylic acid, itaconic acid, allylacetic acid, crotonic acid, vinylacetic acid, fumaric acid, maleic acid, and 2-methylmaleic acid. Particular preference is given to acrylic acid and/or methacrylic acid as monomers Md. Even more preference is given to the polymer dispersions, where the monomers M comprise a monomer Md and where the monomer Md is selected from monoethylenically unsaturated C₃ to C₆, especially C₃ or C₄ monocarboxylic acids and where the amount of monomers Md is preferably in the range of 0.01 to 1.5% by weight, especially 0.05 to 1% by weight, even more preferred in the range of 0.05 to 0.4% by weight, based on the total weight of the monomers M. The relative amounts of monomers Md given here relate to the acidic form of the monomers Md.

The monomers M forming the polymer of the aqueous polymer dispersion may comprise an ethylenically unsaturated monomer Me which, on its own or with a crosslinking agent, has a crosslinking effect. The monomers Me customarily increase the internal strength of a polymer film formed from the aqueous polymer dispersion and thus increases cohesion. The total amount of monomers Me, if present, is typically in the range of 0.01 to 5% by weight, in particular in the range of 0.05 to 4% by weight and especially in the range of 0.1 to 3% by weight, based on the total weight of the monomers M.

Monomers Me may be monoethylenically unsaturated and have at least one reactive functional group which is susceptible to form with another reactive functional group a covalent bond and thereby crosslink the polymer chains formed from the monomers M. This type of monomer is hereinafter termed monomer Me(1). The functional group may be capable of reacting with itself, hereinafter monomers Me(1.1), or with other functional groups within the polymer formed by the polymerization of the monomers M or with an external crosslinking agent, hereinafter monomers Me(1.2). Functional reactive groups in monomers Me(1) include e.g. epoxy, hydroxyl, N-methylol, aldehyde, acetoxyacetyl, hydrolysable silane and keto-carbonyl groups. The total amount of monomers Me(1), if present, is typically in the range of 0.01 to 5% by weight, in particular in the range of 0.05 to 4% by weight and especially in the range of 0.1 to 3% by weight, based on the total weight of the monomers M.

Typical classes of self-crosslinking monomers Me(1.1) are N-alkylol amides, in particular N-methylolamides of monoethylenically unsaturated carboxylic acids having 3 to 6 C atoms, and also their ethers with alkanols having 1 to 4 C atoms, very preferably N-methylolacrylamide and N-methylolmethacrylamide and the methoxy or ethoxy ethers thereof. Typical classes of self-crosslinking monomers Me(1.1) are also monoethylenically unsaturated monomers having a hydrolysable silane-functional group, in particular a trialkoxylsilane group such as vinyltriethoxysilane, vinyltriisopropoxysilane, vi nyltrimethoxysilane, methacryloyloxypropyltrimethoxysilane, methacryloyloxypropyltriethoxysilane, and oligomeric vinylsilanes (e.g., Dynasylan 6490, Evonik).

Typical classes of monomers Me(1.2) are monoethylenically unsaturated monomers having a crosslinker group selected from keto carbonyl, aldehyde and acetoacetoxy groups. Here, the polymer dispersion of the invention can be formulated with a crosslinking agent having amino groups, hydrazine groups, hydrazide groups or semicarbazide groups. Such crosslinking agents comprise polyamines or polyhydrazides, in particular dihydrazides, especially dihydrazides of aliphatic dicarboxylic acids having 2 to 10 carbon atoms such as adipic dihydrazide (ADDH) or oxalic dihydrazide, dihydrazides of aromatic dicarboxylic acids such as phthalic dihydrazide, terephthalic dihydrazide, or diamines such as isophoronediamine and 4,7-dioxadecane-1,1-O-diamine. Examples of monomers having an keto carbonyl, aldehyde or acetoacetoxy group include e.g. acetoacetoxyethyl acrylate, acetoacetoxypropyl methacrylate, acetoacetoxybutyl methacrylate, 2-(acetoacetoxy)ethyl methacrylate, diacetoneacrylamide (DAAM) and diacetonemethacrylamide.

Typical classes of monomers Me(1.2) are also monoethylenically unsaturated monomers having a crosslinker group selected from ureido groups, i.e. a cyclic or non-cyclic urea group in addition to the ethylenically unsaturated double bond. Examples of monomers having an ureido group include e.g. 2-(2-oxo-imidazolidin-1-yl)ethyl acrylate, 2-(2-oxo-imidazolidin-1-yl)ethyl methacrylate, which are also termed 2-ureido (meth)acrylate, N-(2-acryloxyethyl)urea, N-(2-methacryloxyethyl)urea, N-(2-(2-oxo-imidazolidin-1-yl)ethyl) acrylamide, N-(2-(2-oxo-imidazolidin-1-yl)ethyl) methacrylamide, 1-allyl-2-oxoimidazolin and N-vinylurea. Here, the polymer dispersion of the invention will be formulated with a crosslinking agent having aldehyde groups, suitable compounds including e.g. polyaldehydes, as for example a α,ω-dialdehyde having one to ten C atoms, such as glyoxal, glutarialdehyde or malonialdehyde, and/or the acetals and hemiacetals thereof; see EP 0789724.

The total amount of monomers Me(1.2), if present, is typically in the range of 0.05 to 5% by weight, in particular in the range of 0.1 to 4% by weight and especially in the range of 0.2 to 3% by weight, based on the total weight of the monomers M.

The amount of the crosslinking compound is typically chosen such that the molar ratio of reactive groups in the polymer of the polymer dispersion to the reactive groups of the crosslinking agent is in the range of 1:1.5 to 1.5:1.

Preference is given to polymer dispersions, where the monomers M and hence the monomers Me comprise at least one monomer Me(1.2) having a keto carbonyl group such as diacetone acrylamide and diacetone methacrylamide. Polymers containing a monomer with a keto carbonyl group are typically formulated with a dihydrazide such as adipic dihydrazide (ADDH).

Preference is also given to polymer dispersions, where the monomers M and hence the monomers Me comprise at least one monomer Me(1.2) which has an acetoacetoxyethyl group, examples of such monomers Me(1.2) being acetoacetoxyethyl methacrylate.

Preference is also given to polymer dispersions, where the monomers M and hence the monomers Me comprise at least one monomer Me(1.1) having a trialkoxylsilane group such as vinyltriethoxysilane, vinyltriisopropoxysilane, vinyltrimethoxysilane, methacryloyloxypropyltrimethoxysilane, methacryloyloxypropyltriethoxysilane.

In case the monomers M comprise a monomer Ma(1), crosslinking takes place either through reaction with one another or by addition of a further crosslinking agent. Crosslinking preferably does not take place until after actual film formation. Typically, crosslinking takes place at temperatures of below 50° C.

Instead of the functional groups, the monomers Me may have at least two nonconjugated ethylenically unsaturated double bonds, which are hereinafter referred to as monomers Me(2). Examples of suitable monomers Me(2) include
polyacrylic esters, polymethacrylic esters, polyallyl ethers or polyvinyl ethers of polyhydric alcohols having at least 2 OH groups, e.g. 2 to 6 OH groups, hereinafter monomers Me(2.1). The OH groups of the polyhydric alcohols may be completely or partly etherified or esterified, provided that on average they bear at least 2, e.g. 2 to 6 ethylenically unsaturated double bounds. Examples of the polyhydric alcohol components in such crosslinkers Me(2.1) include, but are not limited to dihydric alcohols such as 1,2-ethanediol, 1,2-propanediol, 1,3-propanediol, 1,2-butanediol, 1,3-butanediol, 2,3-butanediol, 1,4-butanediol, but-2-ene-1,4-diol, 1,2-pentanediol, 1,5-pentanediol, 1,2-hexanediol, 1,6-hexanediol, 1,10-decanediol, 1,2-dodecanediol, 1,12-dodecanediol, neopentyl glycol, 3-methylpentane-1,5-diol, 2,5-dimethyl-1,3-hexanediol, 2,2,4-trimethyl-1,3-pentanediol, 1,2-cyclohexanediol, 1,4-cyclohexanediol, 1,4-bis(hydroxymethyl)cyclohexane, hydroxypivalic acid neopentyl glycol monoester, 2,2-bis(4-hydroxyphenyl)propane, 2,2-bis[4-(2-hydroxypropyl)-phenyl]propane, diethylene glycol, triethylene glycol, tetraethylene glycol, dipropylene glycol, tripropylene glycol, tetrapropylene glycol, 3-thiapentane-1,5-diol, and also polyethylene glycols, polypropylene glycols, block copolymers of ethylene oxide or propylene oxide, random copolymers of ethylene oxide and propylene oxide and polytetrahydrofurans having molecular weights of in each case 200 to 10 000. Examples of polyhydric alcohols having more than two OH groups are trimethylolpropane, glycerol, pentaerythritol, 1,2,5-pentanetriol, 1,2,6-hexanetriol, cyanuric acid, sorbitan, sugars such as sucrose, glucose, and mannose. The polyhydric alcohol components in such crosslinkers Me(2.1) having more than two OH groups can be alkoxylated with ethylene oxide or propylene oxide;
monoesters of monoethylenically unsaturated C₃-C₆ monocarboxylic acids, in particular of acrylic acid or methacrylic acid, with monoethylenically unsaturated aliphatic or cycloaliphatic monohydroxy compounds, hereinafter monomers Me(2.2). Examples include vinyl acrylate, vinyl methacrylate, allyl acrylate, allyl methacrylate, cyclohex-2-enyl acrylate, cyclohex-2-enyl methacrylate, norbornenyl acrylate and norbornenyl methacrylate;
straight-chain or branched, linear or cyclic, aliphatic or aromatic hydrocarbons which possess at least two double bonds which in the case of aliphatic hydrocarbons must not be conjugated, hereinafter monomers Me(2.3). Examples include divinylbenzene, divinyltoluene, 1,7-octadiene, 1,9-decadiene, 4-vinyl-1-cyclohexene, trivinylcyclohexane or polybutadienes having molecular weights of 200 to 20 000, in particular divinyl aromatic compounds such as 1,3-divinyl benzene, 1,4-divinyl benzene.

In case the monomers M comprise a monomer Me(2), crosslinking takes place during the polymerization of the monomers M. Crosslinking thus takes place before actual film formation.

The total amount of monomers Me(2), if present, is preferably in the range of 0.01 to 2% by weight, in particular in the range of 0.02 to 1.5% by weight and especially in the range of 0.05 to 1% by weight, based on the total weight of the monomers M.

In very preferred groups of embodiments of the present invention, the monomers Me are selected from the group of monomers Me(1.2), in particular a monomer Me(1.2) having a keto carbonyl group such as in diacetone acrylamide (N-(1,1-dimethyl-3-oxobutyl)acrylamid) or in diacetone methacrylamide (N-(1,1-dimethyl-3-oxobutyl)methacrylamid). Therefore, very preferred groups of embodiments of the present invention relate to aqueous polymer dispersions, where the monomers M comprise a monomer Me and where the monomer Me comprises a monomer Me(1.2), in particular a monomer Me(1.2) having a keto carbonyl group such as diacetone acrylamide and diacetone methacrylamide. Consequently, very preferred groups of embodiments of the present invention relate to aqueous polymer dispersions, where the monomers M comprise a monomer Me and where the monomer Me comprises a monomer Me(1.2), in particular a monomer Me(1.2) having a keto carbonyl group such as diacetone acrylamide and where the aqueous polymer dispersion is formulated with a suitable external crosslinking agent, in particular with a dihydrazide, in case the monomer Me comprises a monomer Me(1.2) having a keto carbonyl group. The total amount of monomers Me(1.2), if present, is typically in the range of 0.01 to 5% by weight, in particular in the range of 0.05 to 4% by weight and especially in the range of 0.1 to 3% by weight, based on the total weight of the monomers M.

The monomers M forming the polymer of the aqueous polymer dispersion may comprise a monoethylenically unsaturated monomer Mf as defined above. The monomers Mf is nonionic and thus different from monomers Md. Due to its high water solubility it is also different from the monomers Ma, Mb and Mc which typically have a solubility in deionized water of less than 100 g/L at 20° C. and 1 bar. By definition, it is also different from the monomers Me. If present, the amount of monomers Mf is typically in the range of 0.1 to 5% by weight, in particular 0.2 to 4% by weight, based on the total weight of the monomers M.

Typical monomers Mf are primary amides of monoethylenically unsaturated monocarboxylic acids having 3 to 6 carbon atoms such as acrylamide and methacrylamide and hydroxyalkyl esters of monoethylenically unsaturated monocarboxylic acids having 3 to 6 carbon atoms, in particular of acrylic acid or methacrylic acid such as 2-hydroxyethyl acrylate, 2- or 3-hydroxypropyl acrylate, 4-hydroxybutyl acrylate, 2-hydroxyethyl methacrylate, 2- or 3-hydroxypropyl methacrylate and 4-hydroxybutyl methacrylate.

In particularly preferred groups of embodiments, the polymers are formed by the monomers M which comprise or consist of:

a) 55 to 80% by weight, in particular 60 to 80% by weight, based on the total weight of the monomers M, of at least one monomer Ma comprising
a1) 25 to 79% by weight or 25 to 75% by weight and especially 30 to 79% by weight or 30 to 75% by weight, based on the total weight of the monomers M, of at least one monomer Ma(1) selected from alkyl acrylates having a branched alkyl radical having 6 to 12 carbon atoms,
a2) 1 to 50% by weight, in particular 5 to 50% by weight, based on the total weight of the monomers M, of at least one monomer Ma(2) selected from alkyl acrylates having a linear alkyl radical of 2 to 6 carbon atoms;

b) 8 to 30% by weight, preferably 12 to 30% by weight, in particular 12 to 28% by weight, especially 14 to 25% by weight, based on the total weight of the monomers M, of acrylonitrile as the monomer Mb;
wherein the weight ratio of monomer Ma(2) to Ma(1) is in particular at most 1.8:1, e.g. in the range of 1:10 to 2:1, more particularly in the range of 1:8 to 1.8:1;

c) 1 to 25% by weight, in particular 2 to 20% by weight, especially 4 to 20% by weight, based on the total weight of the monomers M, of styrene as the monomer Mc;
provided that the total amount of monomer Mb and monomer Mc is 14 to 39.85% by weight or 14 to 39.75% by weight, especially 16 to 39.85% by weight or 16 to 39.75% by weight, based on the total weight of the monomers M;

d) 0.05 to 1.0% by weight, especially 0.05 to 0.4% by weight, based on the total weight of the monomers M, of one or more monoethylenically unsaturated monomers Md having an acidic group and where the monomers Md are preferably selected from the group consisting of monoethylenically unsaturated carboxylic acids, in particular from monoethylenically unsaturated C₃ to C₆, especially C₃ or C₄ monocarboxylic acids;

e) 0.1 to 5% by weight, in particular 0.1 to 4% by weight and especially 0.2 to 3% by weight, based on the total weight of the monomers M, of a monomer Me comprising or consisting of a monoethylenically unsaturated monomer Me(1.2) having at least one keto group which is in particular selected from the group consisting of diacetone acrylamide and diacetone methacrylamide; and optionally

f) 0 to 5% by weight, e.g. 0.1 to 5% by weight, in particular 0.2 to 4% by weight, based on the total weight of the monomers M, of one or more monomers Mf which are in particular selected from the group consisting of hydroxyalkyl esters of monoethylenically unsaturated monocarboxylic acids having 3 to 6 carbon atoms, in particular of acrylic acid or methacrylic acid such as 2-hydroxyethyl acrylate, 2- or 3-hydroxypropyl acrylate, 4-hydroxybutyl acrylate, 2-hydroxyethyl methacrylate, 2- or 3-hydroxypropyl methacrylate and 4-hydroxybutyl methacrylate.

The aqueous polymer dispersion of these particularly preferred groups of embodiments is preferably formulated with a polyhydrazide, in particular with a dihydrazide, more preferably with a dihydrazide of aliphatic dicarboxylic acids having 2 to 10 carbon atoms such as adipic dihydrazide (ADDH) or oxalic dihydrazide, especially with adipic dihydrazide. The amount of the polyhydrazide is typically chosen such that the molar ratio of carbonyl groups in the polymer of the polymer dispersion to the hydrazide groups of the polyhydrazide is in the range of 1:1.5 to 1.5:1.

In general, the polymers in the aqueous polymer dispersions of the present invention which are formed from the polymerized monomers M have a glass transition temperature T_{g} of at most 0° C., in particular at most −5° C., e.g. in the range from −60 to 0° C., in particular in the range from −50 to −5° C., especially in the range from −40 to −10° C. However, the glass transition temperature T_{g} may also be somewhat higher, e.g. up to +10° C.

The actual glass transition temperature depends on the composition of monomers M which form the polymer in the polymer dispersion, i.e. from the type and relative amount of monomers Ma1, Ma2, Mb and optional monomers Mc, Md, Me and Mf, if present. A theoretical glass transition temperature can be calculated from the composition monomer M used in the emulsion polymerization. The theoretical glass transition temperatures are usually calculated from the composition of monomers by the Fox equation:

1/Tg(F)=x₁/Tg₁+x₂/Tg₂+ . . . xₙ/Tgₙ.

In this equation, x₁, x₂, . . . xₙ are the mass fractions of the different monomers 1, 2, . . . n, and Tg₁, Tg₁, . . . Tgₙ are the actual glass transition temperatures in Kelvin of the homopolymers synthesized from only one of the monomers 1, 2, . . . n at a time. Tg(F) is the theoretical glass transition temperature according to Fox. The Fox equation has been described by T. G. Fox in Bull. Am. Phys. Soc. 1956, 1, page 123 and can also be found in Ullmann's Encyclopadie der technischen Chemie [Ullmann's Encyclopedia of Industrial Chemistry], vol. 19, p. 18, 4th ed., Verlag Chemie, Weinheim, 1980. The actual Tg values for the homopolymers of most monomers are known and listed in the references cited above or they can be determined as described above.

For the purposes of the invention, it has been found beneficial, if the particles of the polymer contained in the polymer latex have a Z-average particle diameter in the range from 80 to 800 nm, in particular in the range from 100 to 500 nm, as determined by quasi-elastic light scattering.

If not stated otherwise, the size of the particles as well as the distribution of particle size is determined by quasi-elastic light scattering (QELS), also known as dynamic light scattering (DLS). The measurement method is described in the ISO 13321:1996 standard. The determination can be carried out using a High-Performance Particle Sizer (HPPS). For this purpose, a sample of the aqueous polymer latex will be diluted, and the dilution will be analyzed. In the context of QELS, the aqueous dilution may have a polymer concentration in the range from 0.001 to 0.5% by weight, depending on the particle size. For most purposes, a proper concentration will be 0.01% by weight. However, higher or lower concentrations may be used to achieve an optimum signal/noise ratio. Measurement configuration: HPPS from Malvern, automated, with continuous-flow cuvette and Gilson autosampler. Parameters: measurement temperature 20.0° C.; measurement time 120 seconds (6 cycles each of 20 s); scattering angle 173°; wavelength laser 633 nm (HeNe); refractive index of medium 1.332 (aqueous); viscosity 0.9546 mPa·s. The measurement gives an average value of the second order cumulant analysis (mean of fits), i.e. Z average. The “mean of fits” is an average, intensity-weighted hydrodynamic particle diameter in nm.

The hydrodynamic particle diameter can also be determined by hydrodynamic chromatography fractionation (HDC), as for example described by H. Wiese, “Characterization of Aqueous Polymer Dispersions” in Polymer Dispersions and Their Industrial Applications (Wiley-VCH, 2002), pp. 41-73. For further details, reference is made to the examples and the description below.

The particle size distribution of the polymer particles contained in the polymer dispersion may be monomodal or almost monomodal which means that the distribution function of the particle size has a single maximum. However, the particle size distribution of the copolymer particles contained in the polymer latex is preferably polymodal, e.g. bimodal, which means that the distribution function of the particle size has at least two maxima and or unstructured particle size distribution. Preferably, the particle size distribution has a half-value width h½, i.e. a full width at half maximum (FWHM) of preferably at least ¼ dmax, in particular at least ½ dmax, where dmax is the diameter at the maximum of the particle size distribution.

Preferably, the aqueous polymer dispersions of the present invention have a pH of at least pH 7, e.g. in the range of pH 7 to pH 9, prior to the use in the adhesive composition.

The aqueous polymer dispersions of the present invention generally have solids contents in the range of 30 to 75% by weight, preferably in the range of 40 to 65% by weight, in particular in the range of 45 to 60% by weight. The solids content describes the proportion of nonvolatile fractions. The solids content of a dispersion is determined by means of a balance with infrared moisture analysis. In this determination, a quantity of polymer dispersion is introduced into the instrument, heated to 140° C. and subsequently held at that temperature. As soon as the average decrease in weight falls below 1 mg within 140 seconds, the measurement procedure is ended. The ratio of weight after drying to original mass introduced gives the solids content of the polymer dispersion. The total solids content of the formulation is determined arithmetically from the amounts of the substances added and from their solids contents and concentrations.

Besides the polymer and the optional crosslinking agent, the aqueous polymer dispersions of the present invention may contain further ingredients conventionally present in aqueous polymer dispersions. These further ingredients are, for example, surface active compounds, such as emulsifiers, protective colloids, defoamers and the like. Further ingredients may also be acids, bases, buffers, decomposition products from the polymerization reaction, deodorizing compounds, and chain transfer agents. The amount of the respective individual component will typically not exceed 1.5 wt %, based on the total weight of the polymer dispersion. The total amount of these stated components will typically not exceed 5 wt %, based on the total weight of the polymer dispersion.

Preferably, the amount of volatile organic matter, i.e. the content of organic compounds with boiling points up to 250° C. under standard conditions (101,325 kPa) as determined by ISO 17895:2005 via gas-chromatography is less than 0.5% by weight, in particular less than 0.2% by weight, based on the total weight of the polymer dispersion.

Preferably, the aqueous polymer does not contain any organic biocides or less than 100 ppm of organic biocides.

The aqueous polymer dispersion also contains an aqueous phase, wherein the particles of the polymer are dispersed. The aqueous phase, also termed serum, consists essentially of water and any water-soluble further ingredients. The total concentration of any further ingredient will typically not exceed 10 wt %, in particular 8% by weight, based on the total weight of the aqueous phase.

If the polymer dispersion contains a carbohydrate, the amount of carbohydrate is typically less than 5% by weight, based on the total weight of the aqueous polymer dispersion, or less than 10% by weight, based on the total weight of the polymer formed from the polymerized monomers M. In particular, the polymer dispersion does not contain a carbohydrate at all or less than 2% by weight, based on the total weight of the aqueous polymer dispersion.

The aqueous polymer dispersions of the present invention can be prepared by any method for preparing an aqueous dispersion of a polymer made of polymerized monomers M. In particular, aqueous polymer dispersions of the present invention are prepared by an aqueous emulsion polymerization, in particular by a free radical aqueous emulsion polymerization of the monomers M. The term “free radical aqueous emulsion polymerization” means that the polymerization of the monomers M is initiated by radicals formed by the decay of a polymerization initiator, whereby free radicals are formed in the polymerization mixture. It is therefore also termed “radically initiated emulsion polymerization”. The procedure for radically initiated emulsion polymerizations of monomers in an aqueous medium has been extensively described and is therefore sufficiently familiar to the skilled person [cf. in this regard Emulsion Polymerization in Encyclopedia of Polymer Science and Engineering, vol. 8, pages 659 ff. (1987); D.C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422; and Dispersionen synthetischer Hochpolymerer, F. Hölscher, Springer-Verlag, Berlin (1969)]. The radically initiated aqueous emulsion polymerization is typically carried out by emulsifying the ethylenically unsaturated monomers in the aqueous medium which forms the aqueous phase, typically by use of surface active compounds, such as emulsifiers and/or protective colloids, and polymerizing this system using at least one initiator which decays by formation of radicals and thereby initiates the chain growth addition polymerization of the ethylenically unsaturated monomers M. The preparation of an aqueous polymer dispersion in accordance with the present invention may differ from this general procedure only in the specific use of the aforementioned monomers Ma, Mb, and optionally Mc, Md, Me and Mf. It will be appreciated here that the process shall, for the purposes of the present specification, also encompass the seed, staged, one-shot, and gradient regimes which are familiar to the skilled person.

The free-radically initiated aqueous emulsion polymerization is triggered by means of a free-radical polymerization initiator (free-radical initiator). These may, in principle, be peroxides or azo compounds. Of course, redox initiator systems are also useful. Peroxides used may, in principle, be inorganic peroxides such as hydrogen peroxide or peroxodisulfates such as the mono- or di-alkali metal or ammonium salts of peroxodisulfuric acid, for example the mono- and disodium, -potassium or ammonium salts, or organic peroxides such as alkyl hydroperoxides, for example tert-butyl hydroperoxide, p-menthyl hydroperoxide or cumyl hydroperoxide and also dialkyl or diaryl peroxides such as di-tert-butyl or di-cumyl peroxide. Azo compounds used are essentially 2,2′-azobis(isobutyronitrile), 2,2′-azobis(2,4-di methylvaleronitrile) and 2,2′-azobis(amidinopropyl) dihydrochloride (AIBA, corresponds to V-50 from Wako Chemicals). Suitable oxidizing agents for redox initiator systems are essentially the peroxides specified above. Corresponding reducing agents which may be used are sulfur compounds with a low oxidation state such as alkali metal sulfites, for example potassium and/or sodium sulfite, alkali metal hydrogensulfites, for example potassium and/or sodium hydrogensulfite, alkali metal metabisulfites, for example potassium and/or sodium metabisulfite, formaldehydesulfoxylates, for example potassium and/or sodium formaldehydesulfoxylate, alkali metal salts, specifically potassium and/or sodium salts of aliphatic sulfinic acids and alkali metal hydrogensulfides, for example potassium and/or sodium hydrogensulfide, salts of polyvalent metals, such as iron(II) sulfate, iron(II) ammonium sulfate, iron(II) phosphate, ene diols such as dihydroxymaleic acid, benzoin and/or ascorbic acid, and reducing saccharides such as sorbose, glucose, fructose and/or dihydroxyacetone.

Preferred free-radical initiators are inorganic peroxides, especially peroxodisulfates.

In general, the amount of the free-radical initiator used, based on the total amount of monomers M, is 0.05 to 2 pphm, preferably 0.1 to 1 pphm, based on the total amount of monomers M.

The amount of free-radical initiator required for the emulsion polymerization of monomers M can be initially charged in the polymerization vessel completely. However, it is also possible to charge none of or merely a portion of the free-radical initiator, for example not more than 30% by weight, especially not more than 20% by weight, based on the total amount of the free-radical initiator and then to add any remaining amount of free-radical initiator to the free-radical polymerization reaction under polymerization conditions. Preferably, at least 70%, in particular at least 80%, especially at least 90% or the total amount of the polymerization initiator are added to the free-radical polymerization reaction under polymerization conditions. Addition may be done according to the consumption, batchwise in one or more portions or continuously with constant or varying flow rates during the free-radical emulsion polymerization of the monomers M.

Generally, the term “polymerization conditions” is understood to mean those temperatures and pressures under which the free-radically initiated aqueous emulsion polymerization proceeds at sufficient polymerization rate. They depend particularly on the free-radical initiator used. Advantageously, the type and amount of the free-radical initiator, polymerization temperature and polymerization pressure are selected, such that a sufficient amount of initiating radicals is always present to initiate or to maintain the polymerization reaction.

Preferably, the radical emulsion polymerization of the monomers M is performed by a so-called feed process (also termed monomer feed method), which means that at least 80%, in particular at least 90% or the total amount of the monomers M to be polymerized are metered to the polymerization reaction under polymerization conditions during a metering period P. Addition may be done in portions and preferably continuously with constant or varying feed rate. The duration of the period P may depend from the production equipment and may vary from e.g. 20 minutes to 12 h. Frequently, the duration of the period P will be in the range from 0.5 h to 8 h, especially from 1 h to 6 h. In a multistep emulsion polymerization step, the total duration of all steps is typically in the above ranges. The duration of the individual steps is typically shorter.

For the purpose of the invention, in particular for the stability of the aqueous polymer dispersion under the alkaline conditions of pH values of at least pH 9, in particular at least pH 10, e.g. pH 10 to 12 or pH 10.5 ti 11.5 it was found beneficial, if the majority of the monomer Md, i.e. at least 50% by weight, in particular at least 80% by weight or the total amount of the monomers Md is fed to the polymerization reaction in at least partly neutralized form. Partially neutralized means that the monomers Md are neutralized to a degree of at least 20%, e.g. in the range of 20 to 100% on a molar basis.

Preferably, at least 70%, in particular at least 80%, especially at least 90% or the total amount of the polymerization initiator is introduced into emulsion polymerization in parallel to the addition of the monomers.

The aqueous radical emulsion polymerization is usually performed in the presence of one or more suitable surfactants. These surfactants typically comprise emulsifiers and provide micelles, in which the polymerization occurs and which serve to stabilize the monomer droplets during aqueous emulsion polymerization and also growing polymer particles. The surfactants used in the emulsion polymerization are usually not separated from the polymer dispersion, but remain in the aqueous polymer dispersion obtainable by the emulsion polymerization of the monomers M.

The surfactant may be selected from emulsifiers and protective colloids. Protective colloids, as opposed to emulsifiers, are understood to mean polymeric compounds having molecular weights above 2000 Daltons, whereas emulsifiers typically have lower molecular weights. The surfactants may be anionic or nonionic or mixtures of non-ionic and anionic surfactants.

Anionic surfactants usually bear at least one anionic group which is typically selected from phosphate, phosphonate, sulfate and sulfonate groups. The anionic surfactants which bear at least one anionic group are typically used in the form of their alkali metal salts, especially of their sodium salts or in the form of their ammonium salts.

Preferred anionic surfactants are anionic emulsifiers, in particular those which bear at least one sulfate or sulfonate group. Likewise, anionic emulsifiers which bear at least one phosphate or phosphonate group may be used, either as sole anionic emulsifiers or in combination with one or more anionic emulsifiers which bear at least one sulfate or sulfonate group.

Examples of anionic emulsifiers which bear at least one sulfate or sulfonate group, are, for example,
the salts, especially the alkali metal and ammonium salts, of alkyl sulfates, especially of C₈-C₂₂-alkyl sulfates,
the salts, especially the alkali metal and ammonium salts, of sulfuric monoesters of ethoxylated alkanols, especially of sulfuric monoesters of ethoxylated C₈-C₂₂-alkanols, preferably having an ethoxylation level (EO level) in the range from 2 to 40,
the salts, especially the alkali metal and ammonium salts, of sulfuric monoesters of ethoxylated alkylphenols, especially of sulfuric monoesters of ethoxylated C₄-C₁₈-alkylphenols (EO level preferably 3 to 40),
the salts, especially the alkali metal and ammonium salts, of alkylsulfonic acids, especially of C₈-C₂₂-alkylsulfonic acids,
the salts, especially the alkali metal and ammonium salts, of dialkyl esters, especially di-C₄-C₁₈-alkyl esters of sulfosuccinic acid,
the salts, especially the alkali metal and ammonium salts, of alkylbenzenesulfonic acids, especially of C₄-C₂₂-alkylbenzenesulfonic acids, and
the salts, especially the alkali metal and ammonium salts, of mono- or disulfonated, alkyl-substituted diphenyl ethers, for example of bis(phenylsulfonic acid) ethers bearing a C₄-C₂₄-alkyl group on one or both aromatic rings. The latter are common knowledge, for example from U.S. Pat. No. 4,269,749, and are commercially available, for example as Dowfax® 2A1 (Dow Chemical Company).

Also suitable are mixtures of the aforementioned salts.

Examples of anionic emulsifiers which bear a phosphate or phosphonate group, include, but are not limited to the following salts are selected from the following groups:
the salts, especially the alkali metal and ammonium salts, of mono- and dialkyl phosphates, especially C₈-C₂₂-alkyl phosphates,
the salts, especially the alkali metal and ammonium salts, of phosphoric monoesters of C₂-C₃-alkoxylated alkanols, preferably having an alkoxylation level in the range from 2 to 40, especially in the range from 3 to 30, for example phosphoric monoesters of ethoxylated C₈-C₂₂-alkanols, preferably having an ethoxylation level (EO level) in the range from 2 to 40, phosphoric monoesters of propoxylated C₈-C₂₂-alkanols, preferably having a propoxylation level (PO level) in the range from 2 to 40, and phosphoric monoesters of ethoxylated-co-propoxylated C₈-C₂₂-alkanols, preferably having an ethoxylation level (EO level) in the range from 1 to 20 and a propoxylation level of 1 to 20,
the salts, especially the alkali metal and ammonium salts, of phosphoric monoesters of ethoxylated alkylphenols, especially phosphoric monoesters of ethoxylated C₄-C₁₈-alkylphenols (EO level preferably 3 to 40),
the salts, especially the alkali metal and ammonium salts, of alkylphosphonic acids, especially C₈-C₂₂-alkylphosphonic acids and
the salts, especially the alkali metal and ammonium salts, of alkylbenzenephosphonic acids, especially C₄-C₂₂-alkylbenzenephosphonic acids.

Further suitable anionic surfactants can be found in Houben-Weyl, Methoden der organischen Chemie [Methods of Organic Chemistry], volume XIV/1, Makromolekulare Stoffe [Macromolecular Substances], Georg-Thieme-Verlag, Stuttgart, 1961, p. 192-208.

Preferably, the surfactant comprises at least one anionic emulsifier which bears at least one sulfate or sulfonate group. The at least one anionic emulsifier which bears at least one sulfate or sulfonate group, may be the sole type of anionic emulsifiers. However, mixtures of at least one anionic emulsifier which bears at least one sulfate or sulfonate group and at least one anionic emulsifier which bears at least one phosphate or phosphonate group may also be used. In such mixtures, the amount of the at least one anionic emulsifier which bears at least one sulfate or sulfonate group is preferably at least 50% by weight, based on the total weight of anionic surfactants used in the process of the present invention. In particular, the amount of anionic emulsifiers which bear at least one phosphate or phosphonate group does not exceed 20% by weight, based on the total weight of anionic surfactants used in the process of the present invention.

Preferred anionic surfactants are anionic emulsifiers which are selected from the following groups, including mixtures thereof:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40,
of sulfuric monoesters of ethoxylated alkylphenols, especially of sulfuric monoesters of ethoxylated C₄-C₁₈-alkylphenols (EO level preferably 3 to 40),
of alkylbenzenesulfonic acids, especially of C₄-C₂₂-alkylbenzenesulfonic acids, and
of mono- or disulfonated, alkyl-substituted diphenyl ethers, for example of bis(phenylsulfonic acid) ethers bearing a C₄-C₂₄-alkyl group on one or both aromatic rings.

Particular preference is given to anionic emulsifiers which are selected from the following groups including mixtures thereof:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40,
of mono- or disulfonated, alkyl-substituted diphenyl ethers, for example of bis(phenylsulfonic acid) ethers bearing a C₄-C₂₄-alkyl group on one or both aromatic rings.

As well as the aforementioned anionic surfactants, the surfactant may also comprise one or more nonionic surface-active substances which are especially selected from nonionic emulsifiers. Suitable nonionic emulsifiers are e.g. araliphatic or aliphatic nonionic emulsifiers, for example ethoxylated mono-, di- and trialkylphenols (EO level: 3 to 50, alkyl radical: C₄-C₁₀), ethoxylates of long-chain alcohols (EO level: 3 to 100, alkyl radical: C₈-C₃₆), and polyethylene oxide/polypropylene oxide homo- and copolymers. These may comprise the alkylene oxide units copolymerized in random distribution or in the form of blocks. Very suitable examples are the EO/PO block copolymers. Preference is given to ethoxylates of long-chain alkanols, in particular to those, where the alkyl radical C₈-C₃₀ having a mean ethoxylation level of 5 to 100 and, among these, particular preference to those having a linear C₁₂-C₂₀ alkyl radical and a mean ethoxylation level of 10 to 50 and also to ethoxylated monoalkylphenols.

The surfactants used in the process of the present invention will usually comprise not more than 30% by weight, especially not more than 20% by weight, of nonionic surfactants based on the total amount of surfactants used in the process of the present invention and especially do not comprise any nonionic surfactant. Combinations of at least one anionic surfactant and at least non-ionic surfactant may also be used. In this case, the weight ratio of the total amount of anionic surfactant to the total amount of non-ionic surfactant is in the range of 99:1 to 70:30, in particular 98:2 to 75:25, especially in the range 95:5 to 80:20.

Preferably, the surfactant will be used in such an amount that the amount of surfactant is in the range from 0.2 to 5% by weight, especially in the range from 0.3 to 4.5% by weight, based on the monomers M to be polymerized. In a multistep emulsion step emulsion polymerization, the surfactant will be used in such an amount that the amount of surfactant is usually in the range from 0.2 to 5% by weight, especially in the range from 0.3 to 4.5% by weight, based on the total amount of monomers polymerized in the respective steps.

Preferably, the major portion, i.e. at least 80% of the surfactant used, is added to the emulsion polymerization in parallel to the addition of the monomers. In particular, the monomers are added as an aqueous emulsion to the polymerization reaction which contains at least 80% of the surfactant used in the emulsion polymerization.

It has been found advantageous to perform the free-radical emulsion polymerization of the monomers M in the presence of a seed latex. A seed latex is a polymer latex which is present in the aqueous polymerization medium before the polymerization of monomers M is started. The seed latex may help to better adjust the particle size or the final polymer latex obtained in the free-radical emulsion polymerization of the invention.

Principally, every polymer latex may serve as a seed latex. For the purpose of the invention, preference is given to seed latices, where the particle size of the polymer particles is comparatively small. In particular, the Z average particle diameter of the polymer particles of the seed latex, as determined by dynamic light scattering (DLS) at 20° C. (see below), is preferably in the range from 10 to 80 nm, in particular from 10 to 50 nm. Preferably, the polymer particles of the seed latex is made of ethylenically unsaturated monomers which comprise at least 95% by weight, based on the total weight of the monomers forming the seed latex, of one or more monomers selected from the group consisting of C₁-C₄-alkyl methacrylates such as methyl methacrylate, monomers Mb as defined above such as acrylonitrile and monomers Mc as defined above such as styrene and mixtures thereof.

For this, the seed latex is usually charged into the polymerization vessel before the polymerization of the monomers M is started. In particular, the seed latex is charged into the polymerization vessel followed by establishing the polymerization conditions, e.g. by heating the mixture to polymerization temperature. It may be beneficial to charge at least a portion of the free-radical initiator into the polymerization vessel before the addition of the monomers M is started. However, it is also possible to add the monomers M and the free-radical polymerization initiator in parallel to the polymerization vessel.

The amount of seed latex, calculated as solids, may frequently be in the range from 0.05 to 5% by weight, in particular from 0.05 to 3% by weight, based on the total weight of the monomers in the monomer composition M to be polymerized.

The free-radical aqueous emulsion polymerization of the invention can be carried out at temperatures in the range from 0 to 170° C. Temperatures employed are generally in the range from 50 to 120° C., frequently 60 to 120° C. and often 70 to 110° C. The free- radical aqueous emulsion polymerization of the invention can be conducted at a pressure of less than, equal to or greater than 1 atm (atmospheric pressure), and so the polymerization temperature may exceed 100° C. and may be up to 170° C. Polymerization of the monomers is normally performed at ambient pressure, but it may also be performed under elevated pressure. In this case, the pressure may assume values of 1.2, 1.5, 2, 5, 10, 15 bar (absolute) or even higher values. If emulsion polymerizations are conducted under reduced pressure, pressures of 950 mbar, frequently of 900 mbar and often 850 mbar (absolute) are established. Advantageously, the free-radical aqueous emulsion polymerization of the invention is conducted at ambient pressure (about 1 atm) with exclusion of oxygen, for example under an inert gas atmosphere, for example under nitrogen or argon.

It is frequently advantageous, when the aqueous polymer dispersion obtained on completion of polymerization of the monomers M is subjected to an after-treatment to reduce the residual monomer content. This after-treatment is effected either chemically, for example by completing the polymerization reaction using a more effective free-radical initiator system (known as postpolymerization), and/or physically, for example by stripping the aqueous polymer dispersion with steam or inert gas. Corresponding chemical and physical methods are familiar to those skilled in the art—see, for example, EP-A 771328, DE-A 19624299, DE-A 19621027, DE-A 19741184, DE-A 19741187, DE-A 19805122, DE-A 19828183, DE-A 19839199, DE-A 19840586 and DE-A 19847115. The combination of chemical and physical after-treatment has the advantage that it removes not only the unconverted ethylenically unsaturated monomers, but also other disruptive volatile organic constituents (VOCs) from the aqueous polymer dispersion.

As the polymer contained in the aqueous polymer dispersion contains acidic groups from the monomers Md and optionally from the polymerization initiator, the aqueous polymer dispersion obtained by the process of the invention is frequently neutralized prior to formulating it as a coating composition. The neutralization of acid groups of the polymer is achieved by neutralizing agents known to the skilled of the art after polymerization and/or during the polymerization. For example, the neutralizing agent may be added in a joint feed with the monomers to be polymerized or in a separate feed. Suitable neutralizing agents include organic amines, alkali hydroxides, ammonium hydroxides. In particular, neutralization is achieved by using ammonia or alkali hydroxides such as sodium hydroxide or potassium hydroxide.

As mentioned above, the aqueous polymer dispersion of the present invention is particularly useful as a polymer adhesive/binder in aqueous adhesive formulations, in particular in aqueous adhesive formulations having a pH of at least pH 10, in particular in the range of pH 10.5 to pH 11.5. The aqueous polymer dispersion of the present invention is particularly useful as a polymer adhesive/binder in aqueous flooring adhesive formulations.

Floor covering adhesives are adhesive formulations that are suitable for large-area bonding of floor coverings, especially floor coverings made of non-mineral materials. The term non-mineral means that the material does not essentially consist of mineral material, but contains non-mineral material in an amount of at least floor coverings of non-mineral materials comprising parquet, laminate including wooden laminate, plastic laminate such, as vinyl laminate, and laminate of stone plastic composite (spc laminate), carpet, plastic coverings, including vinyl coverings, PVC coverings and linoleum coverings, cork coverings and the like.

The adhesive formulations of the invention comprise a polymer dispersion of the invention and may consist solely of this dispersion. Typically, the adhesive formulations contains the polymer dispersion in an amount of 20 to 60% by weight, based on the total weight of the adhesive formulation, or 10 to 40% by weight of the polymer of the aqueous polymer dispersion, based on the total weight of the adhesive formulation.

Adhesive formulations having a pH of at least pH 10, in particular in the range of pH 10.5 to pH 11.5 will preferably also contain a pH buffering agent for maintaining a pH of the formulation of least pH 10, in particular in the range of pH 10.5 to pH 11.5.

Typical buffering agents include, but are not limited to
alkalimetal orthosilicates such as sodium orthosilicate or potassium orthosilicate,
alkalimetal siliconates, in particular alkalimetal methylsiliconates such as sodium methylsiliconate or potassium siliconates,
alkanolamines such as 2-aminoethanol, 2-amino-2-methylpropanol, 2-(n-butylamino)ethanol, 2-(dimethylamino)-2-methylpropanol, N,N-dimethylglucamin and mixtures thereof;
alkalimetal phosphates, in particular alkalimetal orthophosphates such as trisodium phosphate or tripotassium phosphate;
alkalimetal monohydrogenphosphates,
aminoacids such as lysine, histidine and arginine, with preference given to lysine.

Amongst the aforementioned buffers, preference is given to alkalimetal orthosilicates and alkalimetal siliconates and combinations thereof.

The amount of buffer is chosen to maintain the pH in the desired range and is typically in the range of 0.5 to 5% by weight, based on the total weight of the adhesive formulation.

The adhesive formulations having a pH of at least pH 10, in particular in the range of pH 10.5 to pH 11.5 may also contain a non-buffering base for adjusting the pH, e.g. an alkalimetal hydroxide such as sodium hydroxide or potassium hydroxide.

Besides the polymer dispersion, the buffering agent and the optional base, the formulation may also comprise further ingredients of the kind customary in adhesives based on aqueous polymer dispersions. These include fillers, colorants, including pigments, thickeners, tackifiers (tackifying resins) and optionally further additives.

The formulation of the invention may further comprise one or more tackifiers. If present, the amount of tackifier is preferably in the range of 5 to 30% by weight, based on the total weight of the adhesive formulation. However, it is also possible that the formulations do not contain any tackifier or contain tackifier in an amount of less than 5% by weight, based on the total weight of the adhesive formulation. The formulations of the invention may also contain a combination of one or more tackifiers and one or more plasticizers, in particular, if the tackifier has a high melting point. However, the amount of plasticizers is preferably not more than 30% by weight, based on the total weight of the combination of tackifier and plasticizer. The total amount of polymer of the polymer dispersion, the tackifier and the optional plasticizer will typically not exceed 55% by weight and thus is in the range of 10 to 55% by weight, in particular 20 to 55% by weight, based on the total weight of the adhesive formulation.

Suitable tackifiers are, for example, natural resins such as rosins and derivatives produced therefrom by disproportionation, isomerization, polymerization, dimerization, or hydrogenation. They may be present in their salt form with monovalent or polyvalent counterions, for example or, preferably, in their esterified form. Alcohols used for the esterification may be mono- or polyhydric.

Also used as tackifiers are hydrocarbon resins, examples being indene-coumarone resins, polyterpene resins, hydrocarbon resins obtained by polymerization of hydrocarbon monomers such as butadiene, pentene, methylbutene, isoprene, piperylene, divinylmethane, pentadiene, cyclopentene, cyclopentadiene, cyclohexadiene, styrene, a-methylstyrene, and vinyltoluene. Likewise preferred tackifiers are polyalkylene glycols and poly(alkylvinyl ethers) such as poly(methylvinyl ethers).

Also possible for use as tackifiers are polyacrylates which have a low molar weight. These polyacrylates preferably have a weight-average molecular weight Mw of below 30 000 g/mol. The polyacrylates consist of C₁-C₁₀ alkyl (meth)acrylates to an extent preferably of at least 60 wt %, more particularly of at least 80 wt %.

In this regard, it was found beneficial, if the tackifier resin does not contain ester groups. In particular, the tackifier resin is selected from the group consisting of hydrocarbon resins, indene coumarone resins, phenol terpene resins, poly(vinyl alkyl ethers), polyalkylene glycols such as polypropylene glycols and combinations thereof.

The tackifier resin can be present in the formulation as such or as a combination with a plasticizer.

The adhesive formulation of the invention preferably further comprises at least one filler. The amount of filler is typically in the range of 25 to 50 wt %, in particular in the range of 35 to 45 wt %, based on the total amount of the formulation.

Suitable fillers are, for example, aluminosilicates such as feldspars, silicates such as kaolin, talc, mica, magnesite, alkaline earth metal carbonates such as calcium carbonate in the form of calcite or chalk, for example, magnesium carbonate, dolomite, alkaline earth metal sulfates such as calcium sulfate, silicon dioxide, etc. In dispersions, finely divided fillers are of course preferred. The fillers may be used as individual components. In practice, however, filler mixtures have been found particularly appropriate, examples being calcium carbonate/kaolin and calcium carbonate/talc. Calcium carbonate is used with particular preference as a filler.

The filler in the formulation of the invention is preferably calcium carbonate with an average particle diameter of 2 to 50 μm or a finely ground quartz having an average particle diameter of 3 to 50 μm or a combination of the two substances. The average particle diameter may be determined by means of light scattering techniques, for example. Examples of calcium carbonate are chalk, limestone, or calcite marble.

The adhesive formulations of the present invention may contain one or more of the following conventional additives: emulsifiers, pigment dispersants, defoamers, thickeners and wetting agents.

Typically one or more of these auxiliaries are present in the adhesive formulations in the following amounts, based in each case on the total weight of the formulation:

### Emulsifiers: 0.1 to 3 wt %;

### Defoamers: 0.05 to 0.4 wt %;

Pigment dispersant: 0.1 to 2 wt %;

### Thickener: 0.001 to 1 wt %; and

Wetting agents: 0.1 to 0.8 wt %,
where the amounts given here refer to the active components.

Preferred emulsifiers have been stated above in the context of the emulsion polymerization of the monomers M.

Suitable defoamers are based, for example, on modified alcohols and polysiloxane adducts. Suitable wetting agents are based, for example, on ethoxylated fatty acids.

Examples of preferred defoamers are mineral oil and silicone oil defoamers and oxyalkylated compounds such as Agitan® 282, Agitan® E255, Byk® 93, FoamStar PB 2706, or FoamStar SI 2210, for example.

Preferred pigment dispersants are, for example, polymers based on carboxylic acids such as, for example, Dispex AA 4135, Dispex CX 4320, Dispex AA 4140, or Dispex AA 4040.

Preferred thickeners are based, for example, on anionic polyacrylate copolymers (such as Rheovis AS 1125, for example), on polyurethanes (such as Rheovis PU 1190, for example), or on cellulose derivatives.

Preferred wetting agents are based, for example, on ethoxylated fatty acids such as, for example, Hydropalat WE 3185, or on sodium salts of sulfosuccinates such as Hydropalat WE 3450, for example.

All embodiments and preferred embodiments set out above are freely combinable with one another, unless the context clearly rules out such combination.

The invention is elucidated in more detail by the examples hereinafter.

### EXAMPLES

Hereinafter the following abbreviations were used:
% b.w. % by weight
AA acrylic acid
AN acrylonitrile
DV dynamic viscosity
EHA 2-ethylhexyl acrylate
EO ethylene oxide
HDC: hydrodynamic chromatography
H DC-PS: particle size determined by HDC
HEA 2-hydroxyethyl acrylate
n-BuA n-butyl acrylate
n.d. not determined
rpm revolutions per minute
S styrene
S.C. solids content

If not stated otherwise, the water used was deionized water.

### 1. Analytics and Characterization

### 1.1 Characterization of the Dispersions

i) Solids contents of the polymer dispersions were measured according to the standard method DIN EN ISO 3251: 2008-06.
ii) Viscosity was measured in mPas according to the standard method DIN EN ISO 3219:1994 using a dynamic shear rheometer (Anton Paar DSR301)) with measuring system Z2 at 500 revolutions per second.
iii) pH values of the polymer dispersions were measured according to the standard method DIN ISO 976:2016-12.
iv) Particle Size Distribution of Polymer Dispersion by DLS
   The particle diameter of the polymer latex was determined by dynamic light scattering (also termed quasielastic light scattering) of an aqueous polymer dispersion diluted with deionized water to 0.001 to 0.5% by weight at 22° C. by means of a HPPS from Malvern Instruments, England. What is reported is the cumulant Z average diameter calculated from the measured autocorrelation function (ISO Standard 13321). The polydispersity index was calculated from a simple 2 parameter fit to the correlation data (the cumulants analysis).
v) Particle Size Distribution of Polymer Dispersion by HDC
   Measurements were carried out using a PL-PSDA particle size distribution analyzer (Polymer Laboratories, Inc.). A small amount of sample of the polymer latex was injected into an aqueous eluent containing an emulsifier, resulting in a concentration of approximately 0.5 g/l. The mixture was pumped through a glass capillary tube of approximately 15 mm diameter packed with polystyrene spheres. As determined by their hydrodynamic diameter, smaller particles can sterically access regions of slower flow in capillaries, such that on average the smaller particles experience slower elution flow. The fractionation was finally monitored using an UV-detector which measured the extinction at a fixed wavelength of 254 nm.
vi) Measurement of hydrolysis
   The dispersion was mixed with 5% b.w. of an aqueous solution of potassium silicate, and the pH of the mixture was adjusted to 11.3 by slowly adding a 5% b.w. an aqueous solution of potassium hydroxide. The mixture was stored at 50° C. for 14 days. Afterwards, the mixture was analyzed by GC. The content of free alcohols which could be evolved by hydrolysis of the respective ester groups in the monomers or polymer is compared with the GC measurement of the pure dispersion. The amount is given in % with respect to theoretical value of complete hydrolysis.

### 1.2. Application Testing of the Adhesive Formulations

vii) Measurement of pH value
   pH values of the polymer formulation were measured according to the standard method DIN ISO 976:2016-12 immediately after preparation of the formulation and after storage at 50° C. for 28 days.
viii) Measurement of viscosity
   The viscosity was measured according to the standard method DIN EN ISO 2555:2018-9 using a Brookfield viscometer DV1 with spindle 6 (equal or less than 50 000 mPas) or spindle 7 (more than 50 000 mPas) at 20 revolutions per minutes, time of test: 60 seconds. The viscosity was measured immediately after preparation of the formulation and after storage at 50° C. for 28 days. Values are given in mPas.
ix) Measurement of wet grab (also called wet tack or green strength)
   The formulation is applied as an adhesive with serrated strip TKB B 1 to fiber cement slabs (e.g., Eternit® 2000, 500×200 mm) in peel direction. NFC (Finett 11 needlefelt floorcovering) strips (150×50×5.2 mm) are laid into the bed of adhesive after venting for 10 minutes and are pressed down with a 2.5 kg roller by rolling back and forth three times. At time intervals (10, 20, 30, and 40 minutes), the coverings are peeled off with a peeling device, and the increase in the peel resistance (in N/5 cm) is ascertained.
x) Measurement of dry grip (also called dry tack or open time)
   The formulation is applied as an adhesive with serrated strip TKB A2 to fiber cement slabs (e.g., Eternit® 2000, 500×200 mm) in peel direction. PVC strips (Tarkett standard 2 mm; 150×50×2 mm) are laid into the bed of adhesive after different venting times (20, 25, 30 and 40 minutes), and are pressed down with a 2.5 kg roller by rolling back and forth three times. Subsequently, the strips are peeled off with a peel instrument, and the increase in the peel resistance (in N/5 cm) is ascertained.
xi) Measurement of heat resistance
   Cement fiberboard panels with a PVC floorcovering (adhesive bond surface 5×2 cm) were stored under standard climatic conditions (1 bar, 23.5° C.) for 14 days. They were then heat-treated at 50° C. in a forced-air drying cabinet for 30 minutes, then stressed in a hanging position with a 2 kg load. The time taken for the adhesive bond to separate is taken as a measure of the heat resistance.
xii) Measurement of dynamic shear strength
   Blocks of oak were coated with the adhesive (coater: serrated strip TKB B3)) and adhesive-bonded overlapping one another (adhesive-bonded surface 26×23 mm) and pressed on with a 2 kilo weight for 1 minute. After the storage time specified under standard climatic conditions (1 bar, 23.5° C., 50% r.h.), the shear strength (in N/mm²) was tested in a tensile tester.
xiii) Measurement of peel strength according to EN ISO 22631
   The formulation is applied as an adhesive with serrated strip TKB A2 to fiber cement slabs (e.g., Eternit® 2000, 150×50×8 mm) in peel direction. PVC strips (Tarkett standard; 200×50×2 mm) are laid into the bed of adhesive after venting times of 5 min and 15 min, respectively, and pressed on with a 3.5 kg roller by rolling back and forth one time. After a storage time of 14 days specified under standard climatic conditions (1 bar, 23.5° C., 50% r.h.), the peel strength (in N/mm) was tested in a tensile tester at a peeling rate of 100 mm/min.

### 2. Materials Used for Preparing the Polymer Dispersions

Seed latex S1: Polystyrene seed latex having a solid content of 33% by weight and a volume average particle diameter of 31 nm—Emulsifier E1: 32% b.w. aqueous solution of a fatty alcohol polyethylene glycol ether sulphate, sodium salt
Emulsifier E2: 20% b.w. aqueous solution of an ethoxylated C16/C18 alcohol having 18 EO units
Defoaming agent Dl: Agitan® LF 305, available from Munzig

### 3. Production of the Polymer Dispersions

### Example 1

A polymerization reactor equipped with a stirrer, a dosage module, a temperature control module and a reflux condenser was charged at room temperature as followed:

Initial charge #0

| | |
|---|---|
| 395.52 g | water |
| 1.82 g | seed latex S1 |

In a first addition vessel was prepared feed/initiator solution #1 by mixing the following components:

Feed/initiator solution #1

| | |
|---|---|
| 102.85 g | 7% b.w. aqueous solution |
| | of sodium persulfate |

In a second addition vessel was prepared feed/emulsion #2 by mixing the following components:

Feed/emulsion #2

| | |
|---|---|
| 195.76 g | water |
| 131.25 g | E1 |
| 30.00 g | E2 |
| 1.20 g | acrylic acid |
| 60.00 g | 20% b.w. aqueous solution |
| | of diacetone acrylamide |
| 240.00 g | acrylonitrile |
| 159.60 g | styrene |
| 691.20 g | 2-ethylhexyl acrylate |
| 108.00 g | n-butyl acrylate |
| 2,66 g | 25% b.w. aqueous solution |
| | of sodium hydroxide |

In a third addition vessel was prepared feed/oxidation solution #3:

Feed/oxidation solution #3

| | |
|---|---|
| 24 g | 10% b.w. aqueous solution |
| | of sodium acetone bisulfite |

In a fourth addition vessel was prepared feed/reduction solution #4:

Feed/reduction solution #4

| | |
|---|---|
| 30.23 g | 13.1% b.w. aqueous solution |
| | of sodium acetone bisulfite |

The initial charge #0 was flushed with nitrogen and heated up to 85° C. under stirring with 150 rpm. Then after reaching the temperature of 85° C., 5% of feed/initiator solution #1 was fed into the reaction vessel in the course of 1 minute and incorporated by stirring at 85° C. over 4 minutes. Then, the remainder of feed/initiator solution #1 and also feed/emulsion #2 were commenced simultaneously and added in the following way, with the aforementioned temperature maintained: a.) feed/initiator solution #1: the remaining feed/initiator #1 was added over 3 h 45 min. b.) Feed/emulsion #2 was added using the following metering profile: 20 min with 105 g/h, then the dosing rate was linearly increased to 473 g/h within 10 min, and then the rest was dosed at that rate. Then, 24 g of water were added to the reactor, and the reaction vessel was stirred for an additional 15 minutes at 85° C. after which 0.6 g of D1 were added.

For chemical deodorization, starting at the same time, but from two spatially separated feeding vessels, feed/oxidation solution #3 and feed/reduction solution #4 were fed into the reaction vessel in the course of 2 hours with a constant feed rate. After 30 minutes, the temperature was lowered continuously to 70° C., over the course of 15 minutes and was then maintained at that temperature for 75 minutes with a gentle stream of nitrogen being passed through the apparatus and through an attached cold trap containing dry ice. Then, the reaction mixture was cooled down. At a temperature below 30° C., 18.75 g of a 32% strength aqueous solution of El was added to the reactor, while continuously stirring, followed by a mixture of 6 g of adipic dihydrazide in 44 g of water. Finally, the pH was slowly adjusted to pH 7.5 by addition of a 5% strength aqueous solution of sodium hydroxide. The properties of the dispersion of example 1 are summarized in table 2.

### Example 2

The polymerization was carried out by the protocol of example 1 with the following amendments:

The feed/emulsion #2 contained the following components:

| | |
|---|---|
| 195.76 g | water |
| 131.25 g | E1 |
| 30.00 g | E2 |
| 1.20 g | acrylic acid |
| 240.00 g | acrylonitrile |
| 159.60 g | styrene |
| 691.20 g | 2-ethylhexyl acrylate |
| 108.00 g | n-butyl acrylate |
| 2.66 g | 25% b.w. aqueous solution |
| | of sodium hydroxide |

### Example 3

The dispersion was prepared by analogy to the protocol of example 2. but the feed/emulsion #2 contained the monomers AA, AN, S, EHA, HEA and n-BuA in the amounts summarized in table 1. The amounts are given in parts by weight. The properties of the dispersion of example 3 are summarized in table 2.

### Example 4

The dispersion was prepared by analogy to the protocol of example 1, but the feed/emulsion #2 contained the monomers AA, AN, S, EHA, HEA, DAAM and n-BuA in the amounts summarized in table 1. The amounts are given in parts by weight. The properties of the dispersion of example 4 are summarized in table 2

### Comparative examples C1, C2 and C3

The comparative dispersions C1, C2 and C3 were prepared by analogy to the protocol of example 2, but the feed/emulsion #2 contained the monomers AA, AN, S, EHA, HEA and n-BuA in the amounts summarized in table 1. The amounts are given in parts by weight. The properties of the dispersion of comparative examples C1 to C3 are summarized in table 2.

TABLE 1
Monomers used and degree of neutralisation

| | n-BuA | EHA | AN | S | HEA | AA | DAAM (20%)¹⁾ | Neut²⁾ |
|---|---|---|---|---|---|---|---|---|
| Example | [g] | [g] | [g] | [g] | [g] | [g] | [g] | % |
| 1 | 108 | 691.2 | 240 | 159.6 | — | 1.2 | 60 | 100 |
| 2 | 108 | 691.2 | 240 | 159.6 | — | 1.2 | — | 100 |
| 3 | 578.4 | 319.2 | 206.4 | 7.2 | 19.2 | 4.8 | — | 60 |
| 4 | 132.0 | 790.8 | 168.0 | 108.0 | — | 1.2 | 60 | 100 |
| C1 | 1050 | — | 120 | — | — | 30 | — | 70 |
| C2 | 534 | 510 | 60 | 36 | 60 | — | — | 35 |
| C3 | 510 | 510 | 60 | 60 | 60 | — | — | 35 |

¹⁾20% by weight aqueous solution of diacetone acrylamide
²⁾degree of neutralisation, feed/emulsion #2 [%]

TABLE 2
Properties of the polymer dispersions of examples 1-4 and C1-C3

| Example | 1 | 2 | 3 | 4 | C1 | C2 | C3 |
|---|---|---|---|---|---|---|---|
| SC [% b.w.] | 55 | 54,9 | 56,4 | 54,9 | 54,8 | 54.0 | 53.4 |
| HDC-PS [nm] | 206 | 201 | 198 | 229 | 486 | 281 | 346 |
| DV [mPas]¹⁾ | 65 | 52 | 96 | 58 | 93 | 163 | 95 |
| pH | 7.5 | 7.5 | 7.5 | 7.5 | 7.5 | 7.5 | 7.5 |
| Example | 1 | 2 | 3 | 4 | C1 | C2 | C3 |
| % hydrolysis²⁾ | n.d. | 0.91 | 0.88 | 0.21 | 0.104 | 0.30 | 0.33 |

¹⁾measured at 500 revolutions per second
²⁾% free alcohol with respect to complete theoretical hydrolysis

### 4. Flooring Adhesive Formulation

### 4.1 Materials Used for Preparing the Flooring Adhesive Formulation:

Resin 1: plasticizer: fatty acid ester polyol with epoxy groups (Sovermol® 1055 of BASF SE)
Resin 2: tackifier resin: terpene phenolic resin (Dertophene® of DRT)

pH-buffer: aqueous solution of potassium orthosilicate having a SiO₂ content of about 21% b.w. and a K20 content of about 8.1% b.w.
Thickener: hydrophobically modified ethoxylated urethane (Rheovis® PU 1191 of BASF SE)
Emulsifier: sodium lauryl sulphate
Defoamer: mixture of modified alcohols and a polysiloxane adduct (Foamstar SI 2210 of BASF SE)
Dispersant: sodium polyacrylate (Dispex AA 4135 of BASF SE)
Wetting agent: non-ionic wetting agent based on alcohol ethoxylate (100%) (Hydropalat WE 3185 EL of BASF SE)
Filler: Calcium carbonate with average particle size d50 of 7 μm (Omyacarb 10 GU of Omya GmbH)

### Formulation F1:

Formulation F1 was prepared from the components listed in the table 3. Table 3 also lists the amounts of the components by weight.

TABLE 3
Composition of formulation F1

| | Amount |
|---|---|
| Ingredient | [% b.w.] |
| Dispersion of | 36.50 |
| example 1 | |
| Resin 1 | 4.50 |
| Resin 2 | 10.50 |
| pH-buffer | 3.00 |
| Thickener | 0.70 |
| Emulsifier | 1.00 |
| Defoamer | 0.30 |
| Dispersant | 0.50 |
| Wetting agent | 0.40 |
| Water | 1.10 |
| NaOH, 20% | 1.50 |
| Filler | 40.00 |
| Sum | 100.00 |

With stirring, and at 23° C., the dispersion of example 1 was admixed with the thickener. Then, resin 1 and resin 2 heated to 105° C. and homogenized prior to the addition were added with stirring over the course of 15 minutes, followed by stirring for 10 minutes more. pH Buffer emulsifier, defoamer, dispersant, wetting agent, water, aq. sodium hydroxide solution were added in succession with stirring. Then, the filler was mixed in with stirring, followed by stirring for 10 minutes more.

### Formulation F2:

Formulation F2 was prepared by analogy to the protocol of formulation F1, but using the dispersion of example 2 instead of the dispersion of example 1.

### Formulation F3:

Formulation F3 was prepared by analogy to the protocol of formulation F1, but using the dispersion of example 3 instead of the dispersion of example 1.

### Formulation F4:

Formulation F4 was prepared by analogy to the protocol of formulation F,1 but using the dispersion of example 4 instead of the dispersion of example 1.

### Comparative Formulation CF1:

Comparative formulation CF1 was prepared by analogy to the protocol of formulation F1, but using the dispersion of example C1 instead of the dispersion of example 1.

### Comparative Formulation CF2:

Comparative formulation CF2 was prepared by analogy to the protocol of formulation F1, but using the dispersion of example C2 instead of the dispersion of example 1.

### Comparative Formulation CF3:

Comparative formulation CF3 was prepared by analogy to the protocol of formulation F1, but using the dispersion of example C3 instead of the dispersion of example 1.

The formulations F1 to F4 and comparative formulations CF1 to CF3 were tested for pH stability and viscosity stability after a storage of 28 d at 50° C.; for shear values, wet grap, dry grib and dimensional stability as described above. The results are summarized in table 4.

TABLE 4

| Test | comments | F1 | F2 | F3 | F4 | CF1 | CF2 | CF3 |
|---|---|---|---|---|---|---|---|---|
| pH stability | ¹⁾ | −0.36 | −0.8 | −0.89 | −0.57 | −0.71 | −0.83 | −0.89 |
| delta pH | | | | | | | | |
| viscosity [mPas] | ²⁾ | −7 | −16 | −5 | 7 | 42 | 6 | 0 |
| peel strength | PVC, 5 min | 2.12 | 1.75 | 1.92 | 1.35 | 3.17 | 0.39 | 0.73 |
| [N/mm] | PVC, 15 min | 0.94 | 0.65 | 0.75 | 0.34 | 1.82 | 0.06 | 0.08 |
| dynamic shear strength | blocks of oak | 1.42 | 1.47 | 1.10 | 0.98 | 0.62 | 0.35 | 0.34 |
| [N/mm²] | | | | | | | | |
| wet grab | 40 min | 18 | 12 | 9 | 19 | 8.5 | 15 | 7 |
| [N/5 cm] | | | | | | | | |

¹⁾Difference of pH after storage of the formulation at 50° C. for 28 d. Negative value indicates a decrease of pH
2)Difference of pH after storage of the formulation at 50° C. for 28 d. Negative value indicates a decrease of pH

1.-28. (canceled)

29. An aqueous polymer dispersion of a polymer made of polymerized ethylenically unsaturated monomers M comprising
a) 55 to 88% by weight, based on the total weight of the monomers M, of at least one monomer Ma consisting of
a1) at least one monomer Ma(1) selected from alkyl acrylates having a branched alkyl radical having 3 to 20 carbon atoms, alkyl methacrylates having a branched alkyl radical having 5 to 20 carbon atoms, where the homopolymer of monomer Ma(1) has a theoretical glass transition temperature of at most 10° C. and
a2) optionally at least one monomer Ma(2) selected from alkyl acrylates having a linear alkyl radical of 2 to 6 carbon atoms;
wherein the weight ratio of monomer Ma(2) to Ma(1) is at most 2:1;
b) 8 to 30% by weight, based on the total weight of the monomers M, of a monomer Mb, which is a monoethylenically unsaturated carbonitrile;
c) 0 to 25% by weight, based on the total weight of the monomers M, of one or more monoethylenically unsaturated non-ionic monomer Mc, whose homopolymers have glass transition temperatures of at least 60° C. and which are different from the monomers Mb and Me;
provided that the total amount of monomer Mb and Mc is in the range of 12 to 40% by weight, based on the total weight of the monomers M;
d) at most 2.0% by weight, based on the total weight of the monomers M, of one or more monoethylenically unsaturated monomers Md having an acidic group;
e) 0 to 5% by weight, based on the total weight of the monomers M, of one or more monomers Me which, alone or with a crosslinking agent, have crosslinking effect and which are different from the monomers Ma to Md;
f) 0 to 10% by weight, based on the total weight of the monomers M, of one or more non- ionic monoethylenically unsaturated monomer Mf which have a water-solubility of at least 100 g/L and which are different from the monomers Me;
provided that the total amount of monomers Md, Me and Mf does not exceed 10% by weight, based on the total weight of the monomers M.

30. The aqueous polymer dispersion of claim 29, where the monomer Ma(1) is selected from alkyl acrylates having a branched alkyl radical having 6 to 12 carbon atoms.

31. The aqueous polymer dispersion of claim 29, where the weight ratio of monomer Ma(2) to monomer Ma(1) is in the range of 1:10 to 2:1.

32. The aqueous polymer dispersion of claim 29, where the amount of monomer Mb is in the range of 12 to 28% by weight, based on the total weight of monomers M.

33. The aqueous polymer dispersion of claim 29, where the monomer Mb is acrylonitrile.

34. The aqueous polymer dispersion of claim 29, where the monomer Mc is a vinylaromatic hydrocarbon monomer, in particular styrene.

35. The aqueous polymer dispersion of claim 29, where the monomer Mc is comprised in the monomers M in an amount in the range of 2 to 20% by weight, based on the total weight of the monomers M.

36. The aqueous polymer dispersion of claim 29, where the monomer Md is selected from monoethylenically unsaturated monocarboxylic acids having 3 to 6 carbon atoms.

37. The aqueous polymer dispersion of claim 29, where the monomer Md is comprised in the monomers M in an amount in the range of 0.05 to 1.5% by weight, based on the total weight of the monomers M.

38. The aqueous polymer dispersion of claim 29, where the monomer Mf is selected from the group consisting of hydroxyalkyl esters of monoethylenically unsaturated monocarboxylic acids having 3 to 6 carbon atoms.

39. The aqueous polymer dispersion of claim 29, wherein the monomers M comprises a monoethylenically unsaturated monomer Me which is a monomer Me(1.2) having at least one keto carbonyl group.

40. The aqueous polymer dispersion of claim 39, which contains an organic compound having at least two functional groups which are capable of reacting with the keto carbonyl group by formation a covalent bond between the carbon atom of the keto group and an atom of the functional group.

41. The aqueous polymer dispersion of claim 29, where the monomer Me is comprised in the monomers M in an amount in the range of 0.01 to 5% by weight, based on the total weight of the monomers M.

42. The aqueous polymer dispersion of claim 29, where the polymer has a glass transition temperature of at most 0° C.

43. The aqueous polymer dispersion of claim 29, where the monomers M comprise
a) 55 to 80% by weight, based on the total weight of the monomers M, of at least one monomer Ma comprising
a1) 25 to 79% by weight, based on the total weight of the monomers M, of at least one monomer Ma(1) selected from alkyl acrylates having a branched alkyl radical having 6 to 12 carbon atoms,
a2) 1 to 50% by weight, based on the total weight of the monomers M, of at least one monomer Ma(2) selected from alkyl acrylates having a linear alkyl radical of 2 to 6 carbon atoms;
b) 12 to 30% by weight, based on the total weight of the monomers M, of acrylonitrile as the monomer Mb;
c) 2 to 20% by weight, based on the total weight of the monomers M, of styrene as the monomer Mc;
provided that the total amount of monomer Mb and monomer Mc is 14 to 39.95% by weight;
d) 0.05 to 1.0% by weight, based on the total weight of the monomers M, of one or more monoethylenically unsaturated monomers Md having an acidic group;
e) 0.1 to 5% by weight, based on the total weight of the monomers M, of a monomer Me comprising a monoethylenically unsaturated monomer Me(1.2) having a keto carbonyl group.

44. The aqueous polymer dispersion of claim 43, which is formulated with a dihydrazide.

45. The aqueous polymer dispersion of claim 29, which is obtained by a process comprising a free-radical aqueous emulsion polymerization of the monomers M.

46. The process for preparing an aqueous polymer dispersion of claim 29, which comprises an aqueous emulsion polymerization of the monomers M.

47. The process of claim 46, where the monomers M comprise a monomer Md and where during the emulsion polymerization the Monomer Md is at least partly present in its anionic form.

48. A method comprising utilizing the aqueous polymer dispersion as defined in claim 29 as a polymer adhesive in an aqueous adhesive formulation having a pH of at least pH 10.

49. An aqueous adhesive formulation having a pH of at least pH 10 and containing the aqueous polymer dispersion as defined in claim 29.

50. The aqueous adhesive formulation of claim 49, further containing a tackifier resin.

51. The aqueous adhesive formulation of claim 50, wherein the tackifier resin is a tackifying resin which does not contain hydrolysable ester groups and which is selected from the group consisting of hydrocarbon resins, indene coumarone resins, phenol terpene resins, poly(vinyl alkyl ethers), polypropylene glycols and combinations thereof, or a combination of the tackifying resin and a plasticizer.

52. The aqueous adhesive formulation of claim 49 further containing a pH buffering agent for maintaining a pH of the formulation of least pH 10.

53. The aqueous adhesive formulation of claim 52, wherein the pH adjusting agent is selected from the group consisting of alkali metal ortho silicates, alkali metal siliconates, amino acids, alkalimetal phosphates, alkalimetal monohydrogen phosphates and alkanol amines.

54. The aqueous adhesive formulation of claim 49 further containing at least one filler.

55. The aqueous adhesive formulation of claim 49 containing
i) 10 to 40% by weight of the polymer of the aqueous polymer dispersion,
ii) 0 to 30% by weight of one or more tackifying resin or a combination of one or more tackifying resin and one or more plasticizer,
iii) 25 to 50% by weight of at least one filler,
iv) a pH buffering agent and optionally an alkali hydroxide in an amount sufficient for adjusting a pH of the formulation to least pH 10,
where the numbers given in percent by weight are the relative amounts of the respective component, based on the total weight of the aqueous adhesive formulation.

56. A flooring adhesive comprising the aqueous adhesive formulation of claim 49.
